(19) United States
(12) Patent Application Publication
(10) Pub. No.: US 2017/0267152 A1
(43) Pub. Date: Sep. 21, 2017

(54) OUTRIGGER AND LANDING GEAR APPARATUS

(71) Applicant: J3I PTE. LTD., Singapore (SG)

(72) Inventor: Adrian Teck Hin Koh, SG (SG)

(21) Appl. No.: 15/093,415

(22) Filed: Apr. 7, 2016

(30) Foreign Application Priority Data
Mar. 21, 2016 (SG) 10201602197V

(51) Int. Cl. B60P 1/64

(52) U.S. Cl. CPC B60P 1/6409; B60P 1/6445

(57) ABSTRACT

To decrease the off-load turn-around time of HGVs, the invention involves inter alia a system including vehicle outrigger and landing gear apparatus adapted to be completely separable from a heavy goods vehicle (HGV) vehicle it is intended to be supported on, including a goods supportable frame mountable to a HGV; and a plurality of moveable outrigger arms fitted to the frame, each outrigger arm further including a landing leg fitted thereto, each outrigger arm being moveable from a stowed to a deployed position enabling the frame to be supported on the landing legs in the deployed position; wherein movement of each outrigger arm from its stowed to its deployed position involves both translation and rotation of the arm relative to the frame; and a HGV.

### RELATED APPLICATIONS

This application claims priority to Singapore Patent Application No. 10201602197V, filed Mar. 21, 2016, incorporated by reference herein.

### FIELD OF THE INVENTION

The present invention relates to an improved outrigger and landing gear apparatus in particular to an improved rotating outrigger and landing gear apparatus, and systems and methods for operating the same.

### BACKGROUND ART KNOWN TO THE APPLICANT

The turn-around time associated with the loading and unloading of medium-to-heavy goods vehicles (HGVs) such as walled semis or flat-bed trailers or loaded truck chassis and cabs is one of the largest costs associated with the transport industry as it is inefficient to have a HGV operator idle for long periods and ways and means to cut down this turnaround time are always being sought by the industry. For example, a loading and unloading evolution in the Takkyubin (Japanese National Delivery Service provided by such companies as Kuroneko Yamato and Sagawa Kyubin) service can take approximately two hours (or more) per 9.2 metre (Giga type) HGV Body.

Detachable truck bodies have been in service incorporating outrigger landing gears 1980's, the leg systems typified by CA 1060924A1, where a pivoting leg system comprising one pair of legs is attached to the underside of the truck bed and pivot out and downward and are locked in place allowing the detachable truck bed to stand in place while the truck body (chassis and cab) can drive off.

Other systems include hydraulically or electrically operated landing legs which require either an electrical hook-up to power lifting motors or hydraulic pumps to deploy and or lift the truck bed. These are expensive and typically do not have manual operations in the event of equipment failure. Fully manual systems also take a longer time to deploy and may be difficult for a single person to operate.

Variants of such landing gear systems do however offer some additional benefits, as disclosed for example in U.S. Pat. No. 4,522,550. This will allow the system to be deployed on uneven ground however operators need to ensure that the leg length be returned to original length each time and it is still a manual system. The manual deployment action in addition, may prove to be an injury hazard as the legs are freely moveable around the horizontal and lateral axes if the operator loses grip or slips.

Accordingly, it is an object of the present invention to try and alleviate at least some of the aforementioned problems.

For the avoidance of doubt, in this specification the term ‘heavy goods vehicle’ or ‘HGV’ includes those of the type known generally as an ‘empty truck chassis and cab’.

### STATEMENTS OF THE INVENTION

With the foregoing in view, the invention, although embodied in several different aspects, is so linked as to form part of a single general inventive concept.

Accordingly, the invention in one aspect resides broadly in a vehicle outrigger and landing gear apparatus adapted to be completely separable from a vehicle it is intended to be supported on including:
a goods supportable frame mountable to a heavy goods vehicle (HGV); and
a plurality of moveable outrigger arms fitted to the frame, each outrigger arm further including a landing leg fitted thereto, each outrigger arm being moveable from a stowed to a deployed position enabling the frame to be supported on the landing legs in the deployed position;
   wherein movement of each outrigger arm from its stowed to its deployed position involves both translation and rotation of the arm relative to the frame.

When such a piece of apparatus is carried or fitted to a HGV, the deployment of the apparatus (which can be relatively rapid and controlled) when it is carrying a filled transport container, detachable HGV body, or goods, means that the HGV can simply drive away from the transport container or goods now supported on the deployed free-standing apparatus, to pick up another container or goods laden apparatus. Furthermore, when the apparatus is in its fully deployed position the legs are standing at a distance from a vehicle able to carry the apparatus which assist the driver of the vehicle to drive off relatively rapidly as the driver need not worry about hitting the legs if he does not drive off in a perfectly straight manner.

In another aspect, the invention resides broadly in a system to enable a HGV to rapidly off-load the goods it is carrying including:
a vehicle outrigger and landing gear apparatus adapted to support a load, the apparatus including;
a goods supportable frame mountable to a heavy goods vehicle (HGV);
a plurality of moveable outrigger arms fitted to the frame, each outrigger arm further including a landing leg fitted thereto, each outrigger arm being moveable from a stowed to a deployed position enabling the frame to be supported on the landing legs in the deployed position;
   and wherein movement of each outrigger arm from its stowed to its deployed position involves both translation and rotation of the outrigger arm relative to the frame; and
a HGV adapted to support the vehicle outrigger and landing gear apparatus.

Providing both the apparatus and the HGV together as part of a system means that the HGV operator can operate the apparatus and this will enable a HGV to off-load it's load carried on the vehicle outrigger and landing gear apparatus and subsequently drive off to pick up for example another load or a non-load supporting apparatus far more rapidly.

Preferably, one or more of the outrigger arms are pneumatically operable and the HGV includes means to connect the vehicle's pneumatic suspension system to the or each pneumatically operable outrigger arm of the vehicle outrigger and landing gear apparatus.

In either the apparatus or the system, preferably at least some of the pneumatically operable outrigger arms are independently operable from the rest. In such form, there are six pneumatically operable outrigger arms, of which two are independently operable from the other four.

In either the apparatus or the system, preferably, rotational and translational movement of each outrigger arm occurs simultaneously.

In either the apparatus or the system, preferably, wherein each outrigger arm is surrounded by one or more fixed collars, the outrigger arm and one or more of its respective collars being provided with one or more pairs of cooperating guide members adapted to cause the rotational movement of the outrigger arm when the outrigger arm moves relative to the collar from its stowed to its deployed position. In such form, the cooperating guide members are respective tongue and groove components.

In either the apparatus or the system, preferably, the, or each collar is a closed collar.

In either the apparatus or the system, preferably, the, or each collar is concentric with the outrigger arm.

In either the apparatus or the system, preferably, the or each collar is a polygonal tube. In such form, at least a portion of the outrigger arm is so sized and mutually polygonally shaped as to cooperatively engage with the polygonal tube. Such an arrangement will serve to trap the outrigger arm in a particular position when the polygonal tube overlies the polygonally shaped portion of the outrigger arm.

In either the apparatus or the system, preferably, the polygonal tube is a square tube.

In either the apparatus or the system, preferably, one or more locking bolts is/are provided to lock each of the outrigger arms in either their stowed or deployed position, the or each locking bolt being moveable between a locked and an unlocked position, wherein the or each locking bolt is located on the polygonal tube. With such an arrangement, as any form of load e.g. a filled (or empty) transport container supported on the frame of the deployed apparatus acts through the legs in a cantilever action in the vertical plane, the larger the number of locking bolts in the outrigger arms the better, as it helps to split the load (be it a filled transport container, detachable HGV body, or goods on flat beds without enclosing structure), between them. By contrast the load in the legs acts vertically through the leg which requires no locking bolts. Accordingly, although, they could be extendible, in either the apparatus or the system, preferably, each landing leg is non-extendible.

As the legs are not extendible, it is particularly preferred if the apparatus is adapted to be pneumatically operable as then, the apparatus could, in principle be so arranged as to be connectable to the pneumatic suspension system of a HGV. This is advantageous as when the vehicle raises and lowers itself through its own pneumatics, the landing legs which themselves, do not possess any lifting capability on their own, (the pneumatic cylinders of the outrigger arms only used for deployment and retraction) are only required to support the frame during deployment. The vehicle simply continues to lower when the landing legs become ground contacting. In such form, the pneumatically actuable vehicle outrigger and landing gear apparatus is actuated by a pair of control boxes.

Although several ways might be envisioned by which the HGV pneumatic suspension system could be connected to the pneumatic systems of the apparatus, in either the apparatus or the system, preferably the pair of control boxes are adapted to control both the locking bolts, and the pneumatically operable outrigger arms.

A typical pneumatic suspension of a HGV is meant to be able to lift up to 24 tons based on the vehicle type, and consequently they possess huge pneumatic air bags to be able to do that as part of the vehicle's pneumatic suspension system. With such an air bag, initially raising the fully laden HGV using the vehicle's own pneumatic suspension system and subsequently deploying the vehicle outrigger and leg apparatus using the same pneumatic suspension system simply is more practical than designing a separate system.

The goods supportable frame mountable to a HGV could be mounted to a flat-bed (without enclosing structure or cargo pod) trailer of a HGV but preferably, it is mounted to the chassis of a HGV.

In either the apparatus or the system, preferably, the apparatus further includes means to engage and disengage the frame from a chassis of a HGV. This has the advantage of enabling the frame to be securely engaged to the vehicle during transportation.

The invention includes within its scope a HGV incorporating the apparatus as specified hereinabove.

The invention further includes within its scope a HGV incorporating the apparatus as specified hereinabove, carrying a filled transport container, detachable HGV body, or goods.

The invention in yet another aspect resides broadly in a method of unloading a HGV including:
providing a HGV containing a filled transport container, detachable HGV body, or goods on a leg containing goods supportable frame;
raising the frame and separating it from the vehicle such that the frame legs in the raised state are ground contacting; and
allowing the vehicle to move off leaving the goods to be unloaded from the frame.

Such a method would greatly decrease the turnaround time for vehicle operators as the rapid off-loading of the transported goods (enabling it to be unloaded at a different time) yet allowing the HGV operator to move off after off-loading is a far faster arrangement than waiting for the goods that have been transported, to be unloaded.

Preferably, the leg containing goods supportable frame is the apparatus as specified herein.

Preferably, the method further includes the step of unlocking the goods supportable frame from the chassis;

Preferably, separation of the apparatus from the vehicle occurs when the outrigger arms are in their deployed position and as the vehicle lowers.

As it is envisioned that a raised unloading area (loading bay) will be present in the unloading area and the filled transport container, detachable HGV body, or goods are off-loaded adjacent this area, preferably, the frame remains in its deployed state during unloading and, if required subsequent reloading.

During recovery of the frame, a HGV positions it's chassis underneath the frame which is standing on its legs. The vehicle then pneumatically raises itself on its pneumatic suspension such that the chassis contacts the underside of the frame lifting it slightly such that the legs are no longer in contact with the ground. (In the case where the HGV does not possess a pneumatic suspension system to raise the frame, the lifting force could be provided by a variety of existing lifting systems such as hydraulic or electric jack systems.) The frame is then secured to the chassis and reconnected to the pneumatic system of the vehicle and the legs and outriggers (in the case of the present apparatus) are retracted and the vehicle then lowers back to its normal driving position height and the vehicle is now able to drive off.

### BRIEF DESCRIPTION OF THE DRAWINGS

In order that the invention may be more readily understood and put into practical effect, reference will now be made to the accompanying drawings wherein:

FIG. 1 is an isometric view from above of a vehicle outrigger and leg apparatus according to one embodiment of the invention and shows the apparatus in a four-outrigger arms deployed configuration with two outrigger arms stowed;

FIG. 2 comprises three views of an outrigger arm in isometric view from above of an outrigger arm and locking bolt of apparatus illustrated in FIG. 1 in both their retracted and stowed (FIG. 2.1) and deployed and locked state (FIG. 2.3). FIG. 2.2 is an exploded view of the major components to demonstrate how everything connects together;

FIG. 3 shows the side elevation and the isometric view of an outrigger arm shaft with square and circular cross-section sections. The figure also shows inter alia a pair of milled key slots in the outrigger shaft body—totally four slots on each shaft body to induce a 90° rotation as the shaft extends, and reversing the rotation as the shaft retracts;

FIG. 4 illustrates isometric (4.1), side (4.2), and end elevations (4.2) of a square collar, and a guide key bolt (4.4) which engages the milled key slots on the outrigger shaft body shown in FIG. 3;

FIG. 5 illustrates how the outrigger arm extends and rotates through 90° to move the leg part from its stowed horizontal position to a deployed vertical position and away from the stowed position, and the effect of the lock bolt to secure the entire system from lateral movement;

FIGS. 6-8 illustrate a pictorial representation of how the apparatus, when operatively connected to a heavy goods vehicle to form a system, deploys from its stowed to its deployed position:

FIG. 9 illustrates a pictorial representation of the front face of the Master control box and Sub control box which serve to connect the pneumatic system of an HGV to the pneumatic components of the rotating outrigger and landing gear apparatus of FIG. 1;

FIG. 10 is an isometric view of the apparatus in its stowed position (FIG. 10.1) and deployed positions (extending outward and rotating the legs downwards) in a six-leg configuration (FIG. 10.2) and in a four-legs deployed configuration (FIG. 10.3), with control boxes and pneumatic air line connections (dashed lines); and

FIG. 11 is a plan view of an alternative embodiment of the outrigger arm, and shows a counterbalancing weight fitted to the leg part of an outrigger arm.

### DESCRIPTION OF THE PREFERRED EMBODIMENT

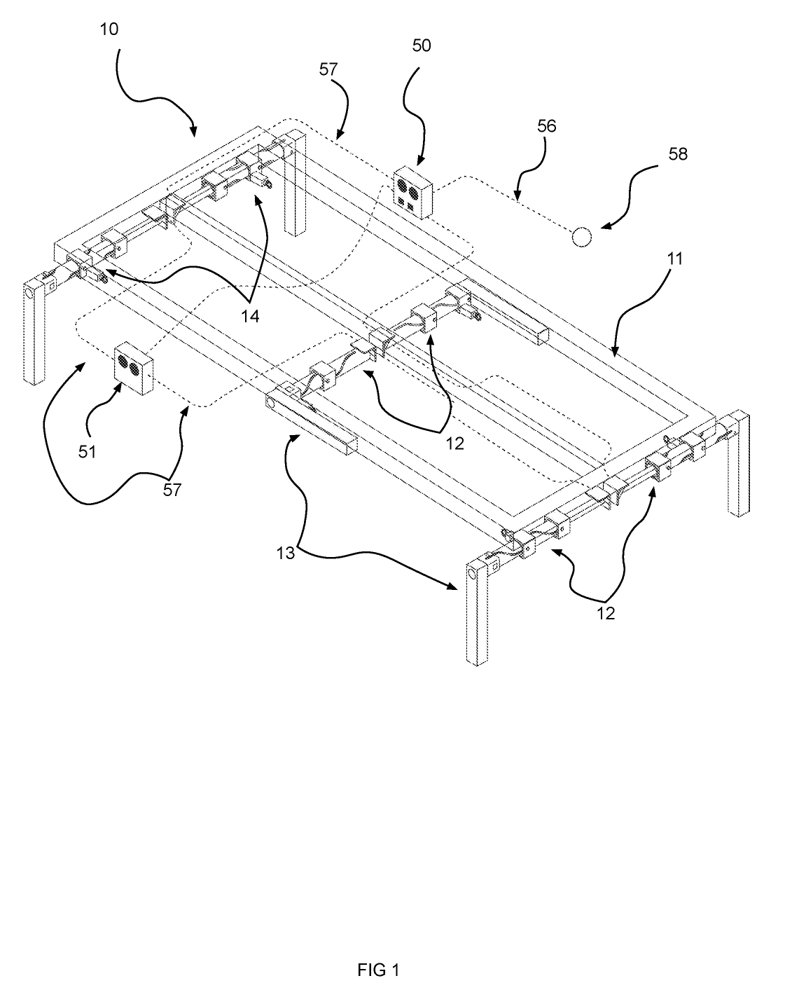

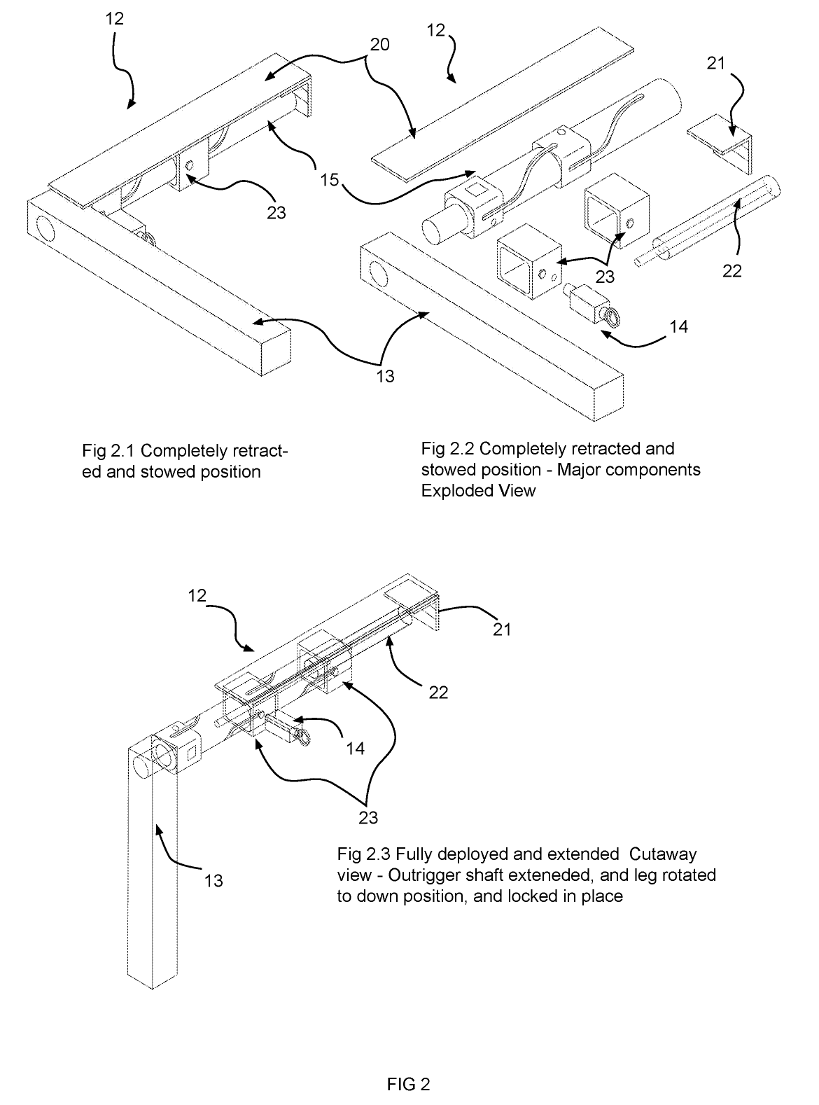

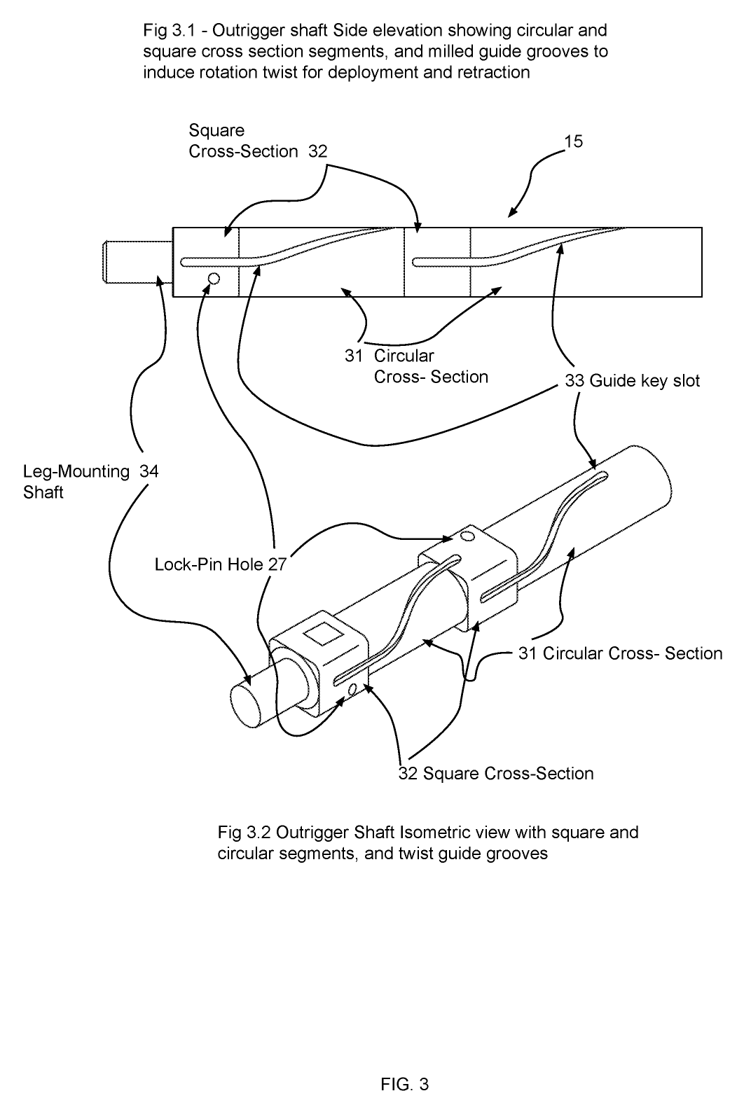

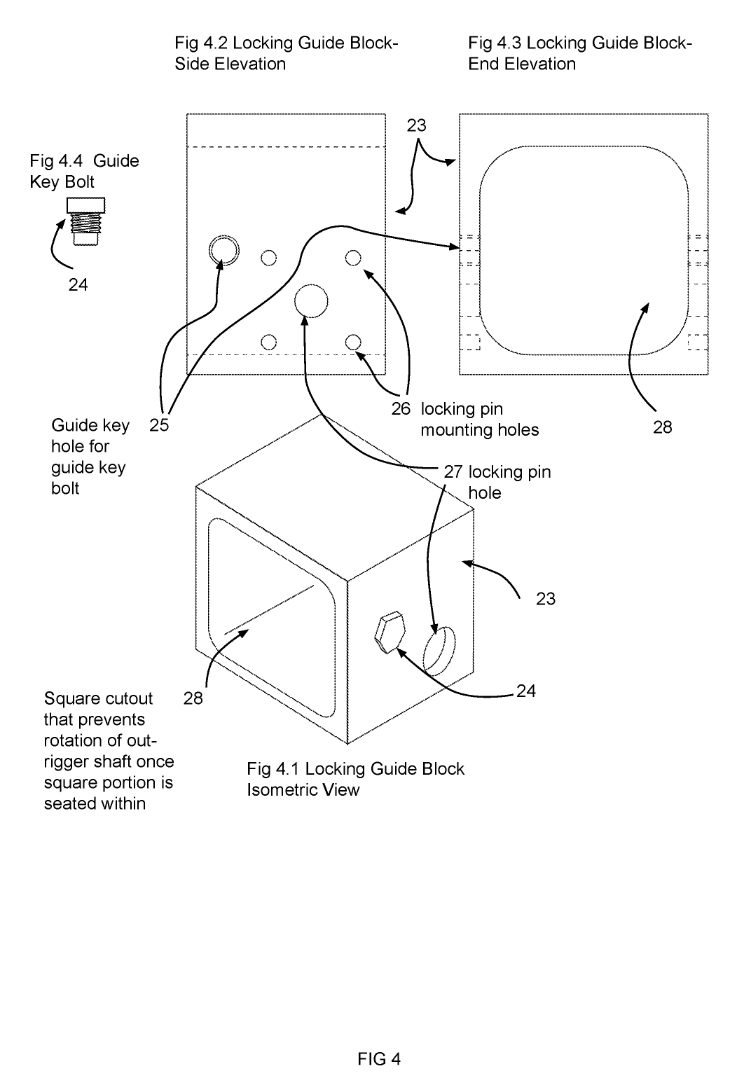

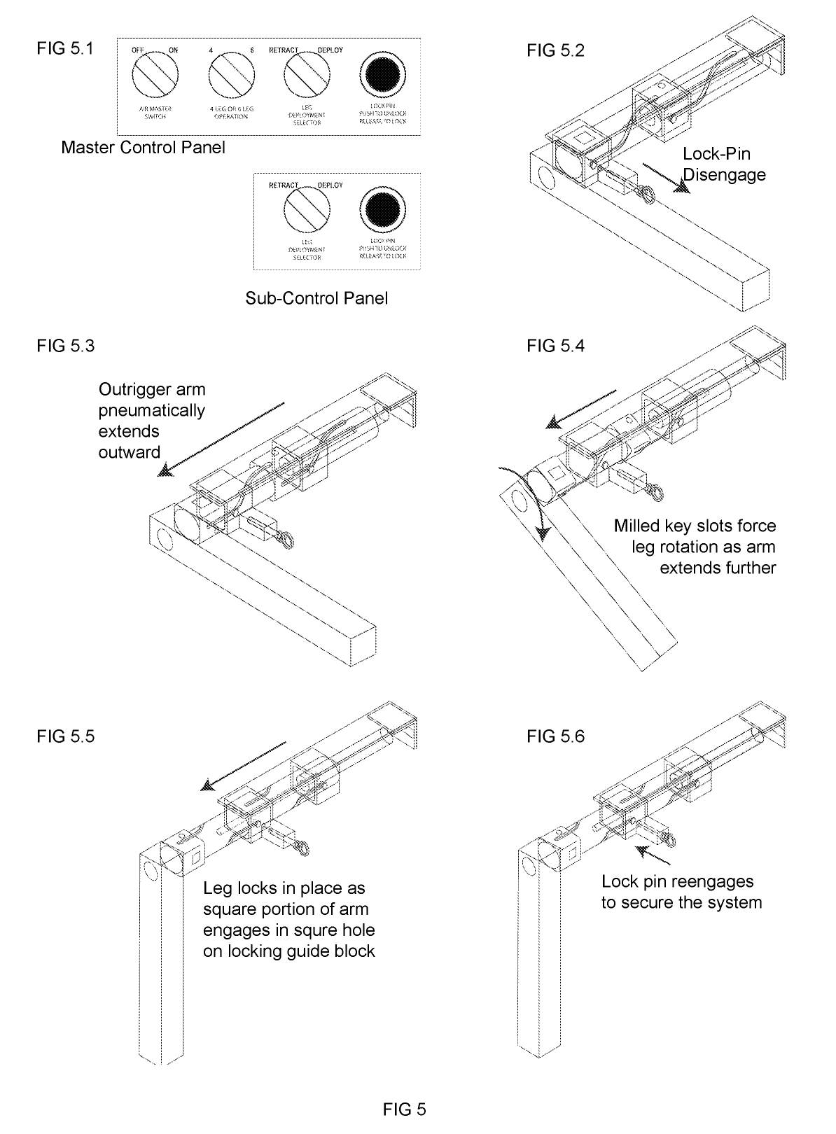

FIG. 1 shows a rotating outrigger and landing gear apparatus of the present invention generally referenced 10, which is adapted to be completely separable from a heavy goods vehicle (HGV) to which it is intended to be carried on, and operatively connected to.

In addition, the apparatus 10 will allow a filled transport container, detachable HGV body, or goods, carried by the HGV and mounted on top of the goods supportable rectangular frame 11, to freely stand on the apparatus 10, when the apparatus 10 is in its fully deployed position.

The frame 11 is mounted to the proximal end of six (in some configurations—typically smaller vehicles, only four are needed), elongate, pneumatically moveable outrigger arms 12 which are able to slide from a stowed to a deployed position. During the translational sliding motion, they are also able to rotate through 90°, rotation occurring only when translational movement occurs. A ground contactable leg 13 forming part of the outrigger arm 12 is connected to the distal end of each of the outrigger arms 12, and during the 90° rotation, the leg 13 moves from a horizontal position with its primary axis parallel with the primary axis of the frame, to a vertical position with its primary axis orthogonal to the primary axis of the frame. In this way, the outrigger arms 12 are moveable between a stowed and a deployed position to support the frame 10 via the legs 13 above the ground in the deployed position. The apparatus 10 also contains a locking bolt 14 per outrigger arm 12. Each of the locking bolts 14 is adapted to be moveable (see later) between a locked and an unlocked position so as to lock each of the arms 12 and legs 13 in either their stowed or deployed position.

The arrangement of the aforementioned component parts of the apparatus 10 are such that when the apparatus 10 in its fully deployed position, on account of both the horizontal telescopic extension and 90° rotation of the leg into a vertical position, the entire apparatus 10 is located at a distance from a vehicle able to carry the apparatus 10.

Each outrigger arm 12 includes the following major components:

a hollow shaft 15 with alternating circular 31 and square 32 cross sections, and four milled guide key slots 33;
a pneumatic cylinder 22 having a pneumatic rod, and means of securing the pneumatic rod of pneumatic cylinder 22 located within the shaft 15 which, when in the stowed position, the pneumatic cylinder 22 rests inside the hollow portion of the shaft 15;
a leg 13 of hollow square cross section;
a solid circular section leg-mounting shaft 34 located at the distal end of the hollow shaft 15 which the leg 13 is welded to;

The upper face of a mounting plate 20 which, at its proximal end is mounted to a right angled mounting bracket 21 (which secures the fixed end of the outrigger arm's pneumatic deployment piston 21, 22) is welded to the underside of the frame; and two hollow square collars 23, also secured to the lower face of mounting plate 20.

Together these two hollow square collars 23 each have two location holes 25 for guide key bolts 24. These guide key bolts 24 directly fit into and cooperate with the guide key slots 33 milled into the outrigger arm shaft 15 and cause the outrigger arm to rotate through 90° as it slides longitudinally by force of the pneumatic piston 22. Four lock bolt mounting holes 26 together with a lock bolt hole 27 are located on one face of each square collar 23 to accommodate a lock-bolt mechanism 14, the lock bolt of which is return spring biased towards and adapted to pass through the lock bolt hole 27 to secure the outrigger arm 12 either its stowed or deployed position. A pull ring 28 is provided for use in manual operation.

Each square collar 23 is so dimensioned as to provide a clearance sliding fit for the square cross-section 32 of shaft 15, and thus snugly fits the square cross section 32 portion of the shaft 15 to prevent any further rotation of the outrigger arm, once this cross-sectional portion 32 of shaft 15 has entered the collar 23.

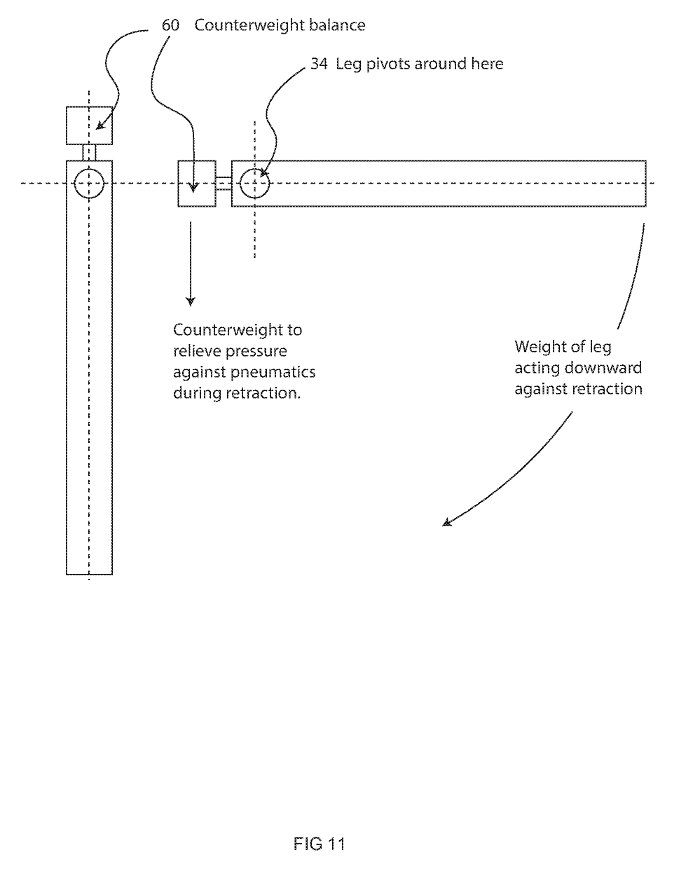

FIG. 11 shows an alternative embodiment of the present invention. The weight of the ground contactable leg 13 forming part of the outrigger arm 12 is relatively heavy and in order to ensure that pneumatic operation of the outrigger arm 12, it may be necessary to provide the leg 13 with a counterbalance weight 60 at its non-ground-contacting end as indicated here. This ensures that a relatively small pneumatic pump in the outrigger arm is capable of lifting/rotating the leg 13 as the counter-balance weight 60 on the other side of the pivot point 34 assists in the ‘lift/rotation’ of the leg during movement especially from its deployed to its stowed position.

A main control box 50 and sub-control box 51 is also provided (intended to be located away from moving parts for safety reasons) which serves as a means of:
a) conveniently linking the pneumatic system of the HGV to the pneumatic systems 22, 28 of the apparatus 10; and
b) actuation for the combined apparatus and HGV system which will enable the HGV to rapidly off-load the goods it is carrying.

The main control box 50 includes a pair of mechanical valves 52, 53:
i) the first valve 52, for the simultaneous release of lock bolts; and
ii) the second valve 53, for the simultaneous control, deployment and return of all of the outrigger arms 12.

The main control box 50 also contains the two additional selector rotary switches 54, 55
i) the first rotary switch 54 allows the operator to select either 4-leg or 6-leg operations depending on the load. In the case where the apparatus only has 4 legs (typically for smaller or lighter HGVs) the rotary switch 53 is deleted, and
ii) the second rotary switch 55 is the Air-Master ON/OFF switch which provides or shuts off air to the pneumatic systems within the apparatus prior to the HGV moving between locations, or when the apparatus is static—i.e. not moving

Essentially a 10 mm hose 56 connected to the HGVs pneumatic system enters the main control box 50 and a bundle of hoses 57 exit the control box 50. The hoses 57 employed throughout are colour coded to aid identification if there is a problem.

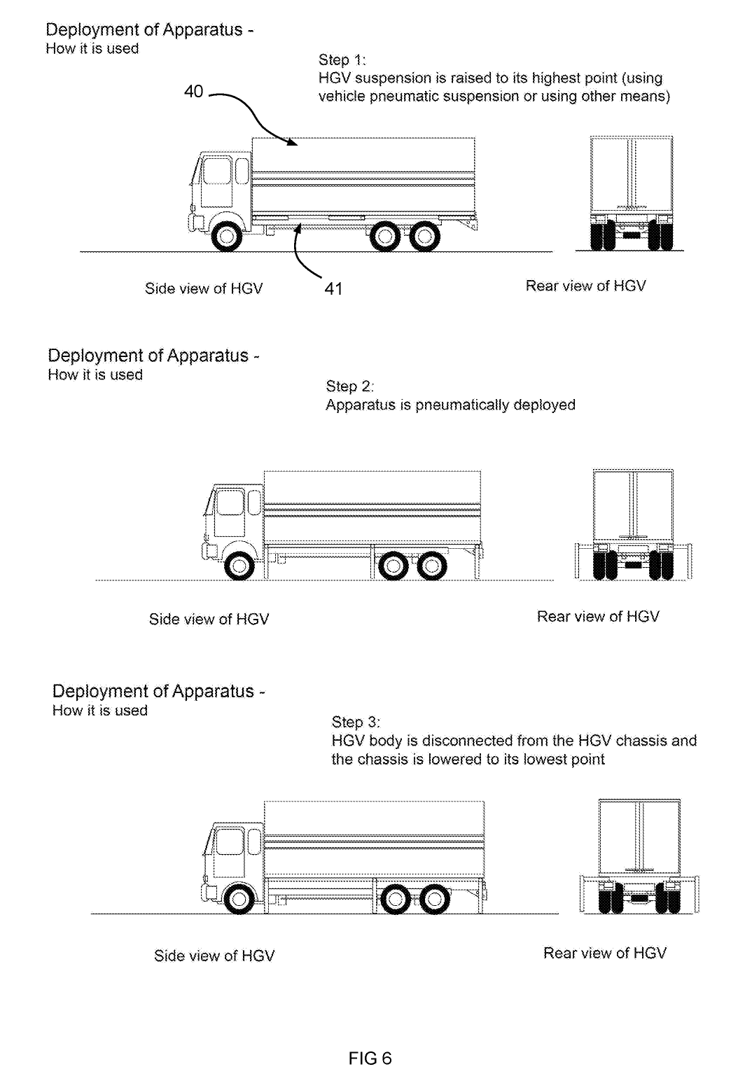

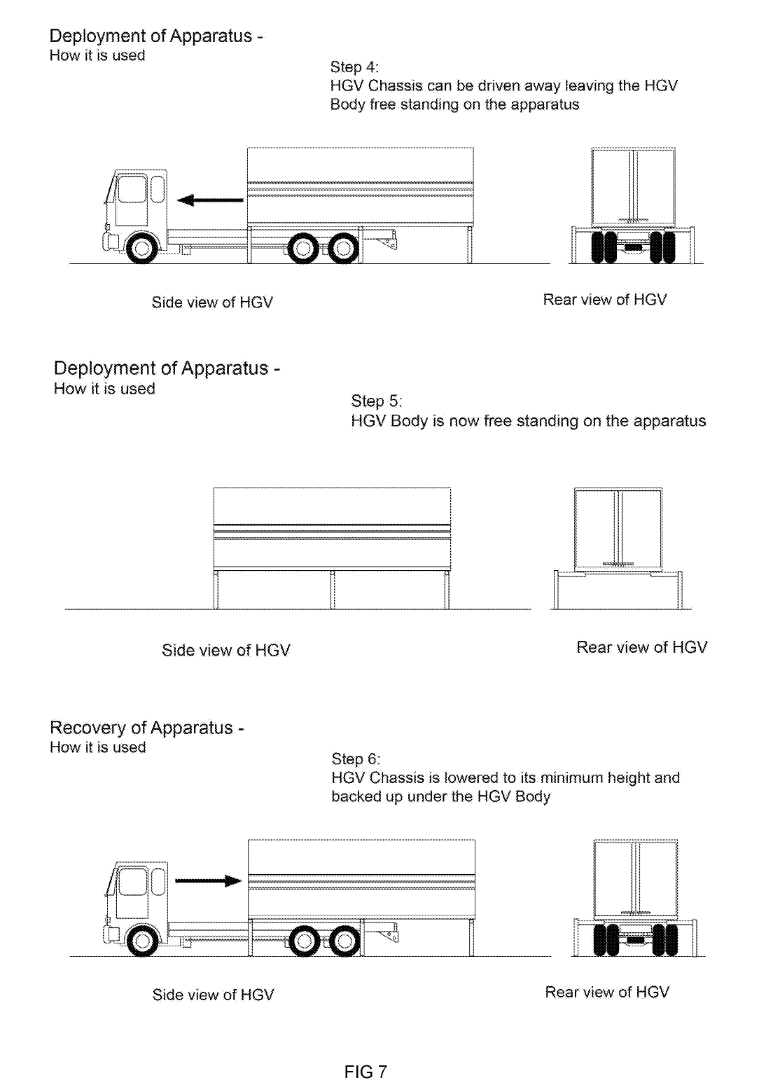

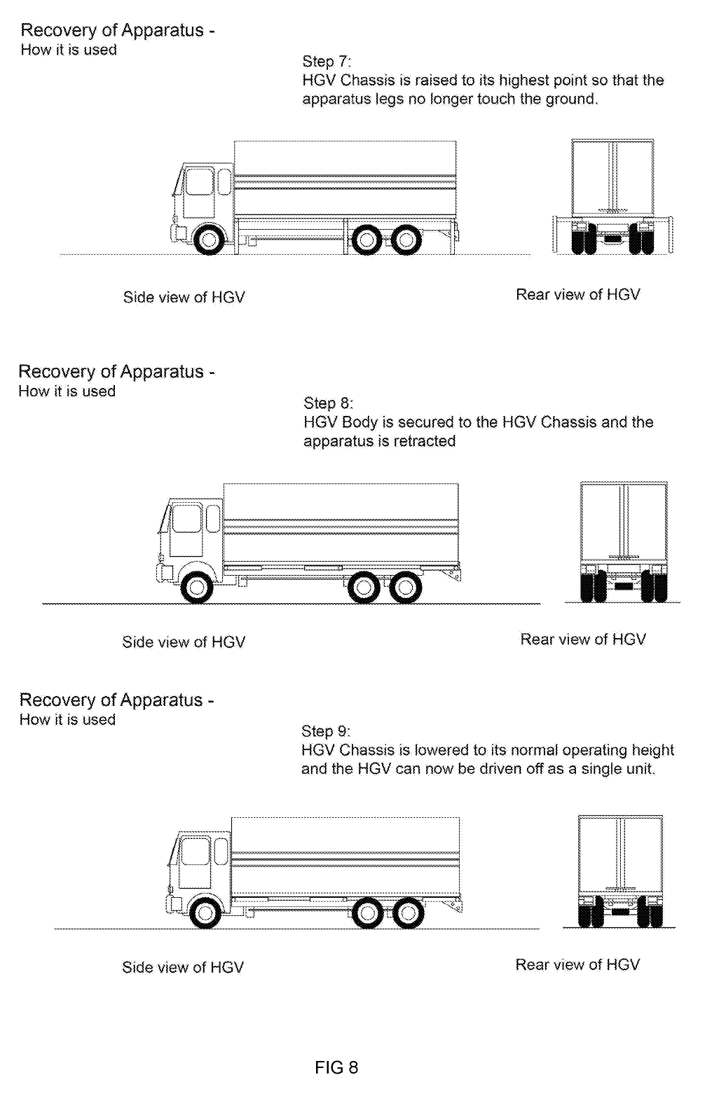

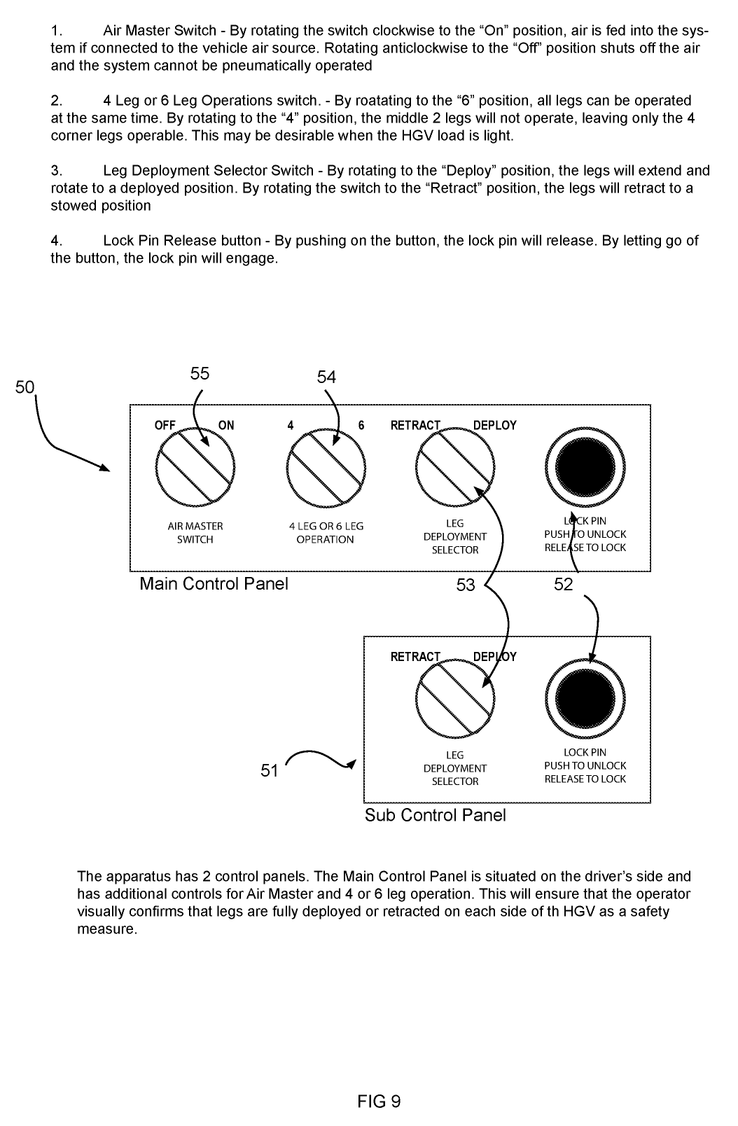

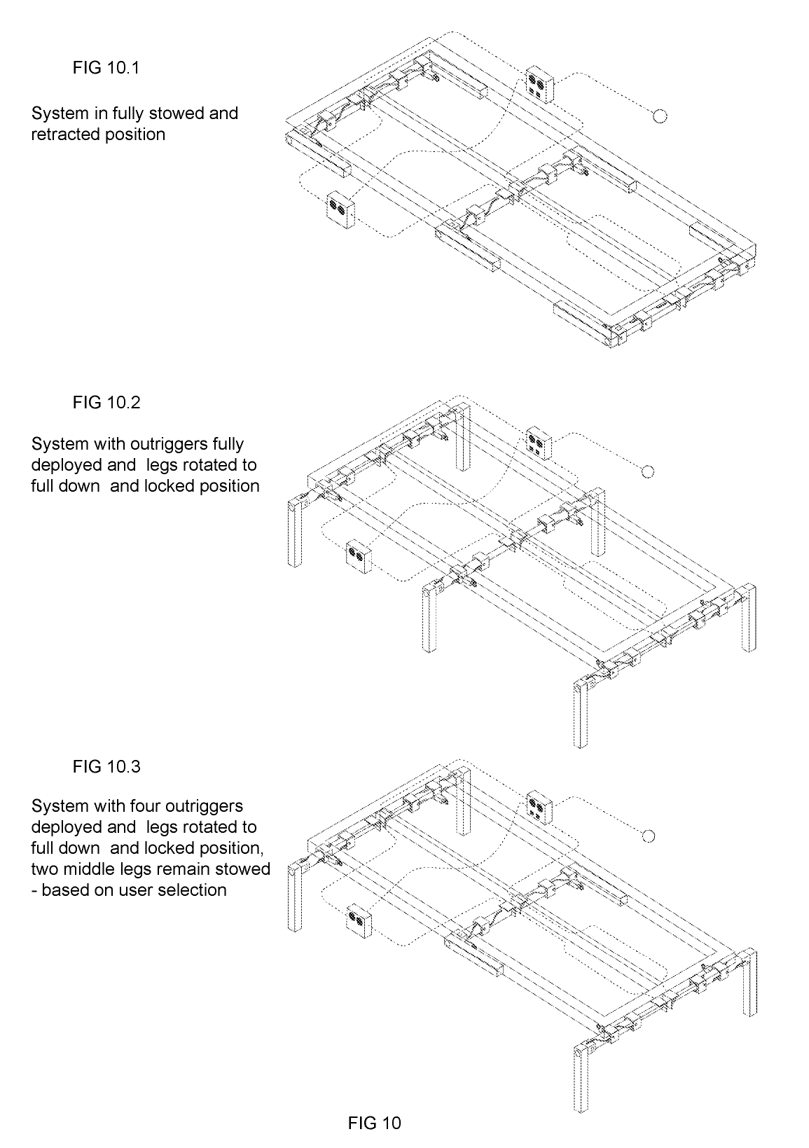

FIGS. 6-8 illustrate the apparatus 10 described above mounted to and operatively connected to a HGV to form a system which acts together. The system illustrated includes an empty truck chassis and cab fitted with the apparatus and a detachable HGV Body, and when fully deployed will enable the chassis unit to drive away while the HGV Body remains standing on the legs 13 of the apparatus 10.

The system is primarily employed where it is desirable to allow the HGV Body to be loaded and unloaded at a raised loading bay platform while standing directly on the deployed apparatus 10. The HGV chassis unit now detached can be driven to pick up a different HGV Body which is ready for delivery. A HGV Body type system will allow the chassis to switch out and pick up a different HGV Body and increase the efficiency of the truck use and lower overall costs.

A method of operating the system is also shown in FIGS. 6-8 and is summarized below.

### Deployment Operation

The HGV comes to a complete stop on flat ground—typically backed up to a loading bay. While the cargo pod 40 is still resting firmly on the frame 11 detachably mounted to the chassis 41, the securing devices or lock that secures the frame to the chassis are disengaged. The HGV is then raised on its pneumatic suspension system to its highest possible level (or a height determined by the operator depending on conditions) and locked in place, with the engine still running. This provides compressed air for operation of the pneumatic system. The operator first ensures that the master switch 55 is in the “ON” position and supplies compressed air to the pneumatic system to the apparatus. The operator then pushes and holds down lock-bolt valve actuator 52 to disengage the lock bolt mechanisms 14 and move them from their locked to their unlocked position.

The operator then rotates the outrigger arm deployment switch 53 to the deploy which causes the outrigger shafts 15 to slidably extend relative to the collars 23 to their fully extended position at the same time rotate through 90° so that the legs 13 move from their stowed position along the horizontal plane to their deployed position in the vertical plane.

The operator then releases valve actuator 52 causing the locking bolt mechanisms 14 to move from their from their unlocked to their locked position. The operator then rotates the master switch 55 to its “OFF” position and then disconnects the 10 mm hose connector 58 form the HGV chassis. The operator finally pneumatically lowers the suspension of the chassis of the HGV to its lowest point and is then able to safely drive the chassis away now that the HGV Body is free standing on the apparatus 10.

### Stowing Operation

The operator pneumatically lowers the chassis to its lowest position, and positions the chassis directly below the apparatus 10 supporting a HGV Body, and aligned correctly. Subsequently the operator pneumatically raises the chassis to its highest position and secures the chassis to the frame of the apparatus 10 by means of their locking system and connects the 10 mm hose connector 58 to the apparatus 10, followed by turning the master switch 55 into the “ON” position. The operator then presses and holds down valve actuator 52, to release the lock bolt mechanisms 14 from their locked position.

The operator then rotates the outrigger arm deployment selector switch 53 to the “Retract” position which will cause the legs 13 of the outrigger arms 12 to rotate up from the vertical plane through 90° to the horizontal plane as the shaft IS retract inwards and both of the square cross sections 32 re-engage their respective stowed collars 23. The operator then releases valve actuator 52 causing the locking bolt mechanisms 14 to move from their unlocked to their locked position, preventing the shaft 15 from potentially sliding/deploying. The operator then rotates the master switch 55 to its “OFF” position. The operator is then in a position to secure or lock the frame I to the chassis and lower the chassis to the normal driving position before driving away.

The system can be operated by a single person and (excluding chassis raising and lowering) has a cycle time of less than 30 seconds which greatly reduces the turn-around time for both loading and unloading an HGV and can be used with the chassis of a single (rigid) HGV or the chassis of an articulated HGV.

This stowing operation can be used not only to connect an empty (non-loaded HGV body) apparatus, but one supporting a loaded HGV body.

The system is so adapted to be able to carry a static load of 4 tons per leg, which when combined typically exceeds the maximum cargo weight of a HGV by at least two times. A manual override system is also in place enabling deployment of the outriggers arms from their stowed to their deployed positions to be possible in case the pneumatic system fails.

1. A vehicle outrigger and landing gear apparatus adapted to be completely separable from a vehicle it is intended to be supported on including:
a goods supportable frame mountable to a heavy goods vehicle (HGV); and
a plurality of moveable outrigger arms fitted to the frame, each outrigger arm further including a landing leg fitted thereto, each outrigger arm being moveable from a stowed to a deployed position enabling the frame to be supported on the landing legs in the deployed position;
wherein movement of each outrigger arm from its stowed to its deployed position involves both translation and rotation of the arm relative to the frame.

2. Apparatus as claimed in claim 1, wherein the apparatus is so adapted as to enable rotational and translational movement to occur simultaneously.

3. Apparatus as claimed in claim 1, wherein each outrigger arm is surrounded by one or more fixed collars, the outrigger arm and one or more of its respective collars being provided with one or more pairs of cooperating guide members adapted to cause the rotational movement of the outrigger arm when the outrigger arm moves relative to the collar from its stowed to its deployed position.

4. Apparatus as claimed in claim 3, wherein the cooperating guide members are respective tongue and groove components.

5. Apparatus as claimed in claim 4, wherein the, or each collar is a closed collar.

6. Apparatus as claimed in claim 5, wherein the or each collar is concentric with the outrigger arm.

7. Apparatus as claimed in 6, wherein, the or each collar is a polygonal tube.

8. Apparatus as claimed in claim 7, wherein at least a portion of the outrigger arm is so sized and polygonally shaped as to cooperatively engage with the polygonal tube.

9. Apparatus as claimed in claim 8, wherein the polygonal tube is a square tube.

10. Apparatus as claimed in claim 2, wherein one or more locking bolts is/are provided on the collar to lock each of the outrigger arms in either their stowed or deployed position, the or each locking bolt being moveable between a locked and an unlocked position.

11. Apparatus as claimed in claim 10, wherein the, or each locking bolt is/are provided with biasing means adapted to bias the, or each locking bolt towards an engaged (or locking) position.

12. Apparatus as claimed in claim 1, wherein the apparatus is adapted to be pneumatically operable and connectable to the pneumatic suspension system of a HGV.

13. Apparatus as claimed in claim 12, wherein at least some of the pneumatically operable outrigger arms are independently operable from the rest.

14. Apparatus as claimed in claim 13, wherein there are six pneumatically operable outrigger arms, of which two are independently operable from the other four.

15. Apparatus as claimed in claim 1, wherein, the apparatus further includes means to engage and disengage the frame from a chassis of a HGV.

16. Apparatus as claimed in claim 1, wherein each landing leg includes a counterbalancing mechanism.

17. A HGV incorporating the apparatus as claimed in claim 1.

18. A HGV incorporating the apparatus as claimed in claim 17, carrying a filled transport container, detachable HGV body, or goods.

19. A system to enable a HGV to rapidly off-load the goods it is carrying including:
a vehicle outrigger and landing gear apparatus adapted to support a load, the apparatus including:
a goods supportable frame mountable to a heavy goods vehicle (HGV);
a plurality of moveable outrigger arms fitted to the frame, each outrigger arm further including a landing leg fitted thereto, each outrigger arm being moveable from a stowed to a deployed position enabling the frame to be supported on the landing legs in the deployed position;
and wherein movement of each outrigger arm from its stowed to its deployed position involves both translation and rotation of the outrigger arms relative to the frame; and
a HGV adapted to support the vehicle outrigger and landing gear apparatus.

20. The system as claimed in claim 19, wherein the apparatus is so adapted as to enable rotational and translational movement to occur simultaneously.

21. The system as claimed in claim 20, wherein each outrigger arm is surrounded by one or more fixed collars, the outrigger arm and one or more of its respective collars being provided with one or more pairs of cooperating guide members adapted to cause the rotational movement of the outrigger arm when the outrigger arm moves relative to the collar from its stowed to its deployed position.

22. The system as claimed in claim 21, wherein the cooperating guide members are respective tongue and groove components.

23. The system as claimed in claim 22, wherein the, or each collar is a closed collar.

24. The system as claimed in claim 23, wherein the, or each collar is concentric with the outrigger arm.

25. The system as claimed in claim 24, wherein, the, or each collar is a polygonal tube.

26. The system as claimed in claim 25, wherein at least a portion of the outrigger arm is so sized and polygonally shaped as to cooperatively engage with the polygonal tube.

27. The system as claimed in claim 26, wherein the polygonal tube is a square tube.

28. The system as claimed in claim 27, wherein one or more locking bolts is/are provided on the collar to lock each of the outrigger arms in either their stowed or deployed position, the or each locking bolt being moveable between a locked and an unlocked position.

29. The system as claimed in claim 28, wherein the, or each locking bolt is/are provided with biasing means adapted to bias the, or each locking bolt towards an engaged (or locking) position.

30. The system as claimed in claim 19, wherein the apparatus is adapted to be pneumatically operable and connectable to the pneumatic suspension system of the HGV.

31. The system as claimed in claim 30, wherein at least some of the pneumatically operable outrigger arms are independently operable from the rest.

32. The system as claimed in claim 31, wherein there are six pneumatically operable outrigger arms, of which two are independently operable from the other four.

33. The system as claimed in claim 19, wherein, the apparatus further includes means to engage and disengage the frame from a chassis of a HGV.

34. The system as claimed in claim 19, wherein each landing leg includes a counterbalancing mechanism.

35. A method of unloading a HGV including:
providing a HGV containing a filled transport container, detachable HGV body, or goods supported on a vehicle outrigger and landing gear apparatus as claimed in claim 1;
raising the frame and separating it from the vehicle such that the frame legs in the raised state are ground contacting; and
allowing the vehicle to move off leaving the goods to be unloaded from the frame.

36. The method as claimed in claim 35, wherein, the method further includes the step of unlocking the goods supportable frame from the chassis.

37. The method as claimed in claim 36, wherein, separation of the apparatus from the vehicle occurs when the outrigger arms are in their deployed position and as the vehicle lowers.
